(19) United States
(12) Patent Application Publication
(10) Pub. No.: US 2003/0048257 A1
(43) Pub. Date: Mar. 13, 2003

(54) Telephone set having a touch pad device

(75) Inventor: Sami P. Mattila, Turku (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Mobile Phones Ltd.

(21) Appl. No.: 09/948,946

(22) Filed: Sep. 6, 2001

(51) Int. Cl. G09G 5/00

(52) U.S. Cl. 345/169

(57) ABSTRACT

A mobile phone comprising a housing for mounting a display panel, a flip having an inner side and an outer side movably connected to the housing operable in an open position or a closed position, a keypad having a plurality of keys, and a touch pad device, disposed on the housing and facing the inner surface of the flip when the flip is in the closed position. When the flip is in the open position, the user can use an object to touch the touch pad device for inputting information into the electronic device. The keypad can be located on the inner surface or outer surface of the flip. If the keypad is located on the outer surface, it is preferable to have a plurality of actuating members located on the inner surface, which can be caused to touch the touch pad device by pressing the keys.

### CROSS REFERENCE TO RELATED APPLICATIONS

Reference is made to pending patent application Ser. No. 09/928,967, entitled “Method and Device for Detecting Touch Pad Input”, assigned to the assignee of the present invention and filed on Aug. 13, 2001, and pending patent application Ser. No. 09/928,929, entitled “Method for Preventing Unintended Touch Pad Input Due to Accidental Touching”, assigned to the assignee of the present invention and filed on Aug. 13, 2001.

### FIELD OF THE INVENTION

The present invention relates generally to a hand-held electronic device, such as a mobile phone, a personal digital assistant (PDA), or a communicator, and, more specifically, to a hand-held electronic device having a touch pad for data/information entry.

### BACKGROUND OF THE INVENTION

It is known that a hand-held electronic device, such as a mobile phone, generally includes a phone body for mounting thereon a keypad, an antenna, a microphone, a speaker and a display panel, and for accommodating various electronic components inside the phone body. In some telephones, such as those disclosed in U.S. Pat. No. 6,038,313 (Collins) and U.S. Pat. No. 5,715,524 (Jambhekar et al.), the keypad is located on a flip, which is mechanically and electronically connected to the phone body. Furthermore, the display also serves as a touch pad device to allow a user to execute touch pad functions or to input information into the telephone.

A touch pad is usually defined as a touch-sensitive user interface area in an electronic device, which allows a user to input information or a command to the device by pressing the touch sensitive area. The touch pad can be used as a keypad having a designated functionality. For example, a touch pad can be used as an on/off switch and the user can turn the electronic device on or off by pressing the touch sensitive area. The touch pad can have several selectable functions. For example, the touch pad can be used as a keypad having a plurality of control keys of different functions to allow the user to enter or select one function at a time.

In some touch pads, it is required to press the pad surface in order to deform it. In such a touch pad, several layers of material, separated by thin spacers, are used to form a grid of vertical and horizontal rows of electrodes. An electrical current is maintained in the grid of electrodes. When a user presses the pad, the layers are caused to make contact with each other at the pressing point, thereby interrupting the current in the electrode grid. A detection circuit is used to detect the interruption in the current and determine the location of the pressing point on the pad. In other touch pads, mere touching of the pad surface by a finger is sufficient. This latter type of touch pad can be of a resistive-type or capacitive-type. On a resistive-type touch pad, a thin, electrically conductive and resistive layer is coated on the surface of the touch surface area. On a capacitive-type touch pad, a coated layer having a matrix of pixel-like capacitors is provided on the touch sensitive area. When a finger touches the surface, it changes the electrical characteristics of the coated layer. By measuring the resistance or capacitance values at a number of surface points corresponding to the pressing point, the location of the pressing point can be determined. On an inductive-type touch pad, inductive elements are distributed over the touch pad area. A stylus made of an inductive material is used to change the signals transmitted through the inductive elements so that the presence of the style in the proximity of the touch pad can be detected.

In U.S. Pat. No. 6,038,313 and U.S. Pat. No. 5,715,524, the touch pad is disposed on top of the display. While such an implementation can reduce the size of the electronic device, it limits the choice of touch pad functions and increases the production cost of the electronic device. Because the touch pad device is implemented directly on top of the display area of the display panel, the touch pad device, including all the electrodes and the substrates for supporting the electrodes, must be sufficiently transparent.

It is advantageous and desirable to provide an electronic device having a touch pad to allow a user to input data/information into the electronic device or execute a touch pad function, wherein the touch pad device is disposed in a way that can reduce the production cost of the electronic device and that also provides more choices in selecting the touch pad type to be implemented on the electronic device.

### SUMMARY OF THE INVENTION

It is a primary objective of the present invention to provide an electronic device, such as a mobile phone, having a touch pad to allow a user to execute a device function or input data/information to the electronic device, wherein the touch pad device is disposed in a way that can reduce the production cost while allowing more choices of the touch pad type. This objective can be achieved by implementing a touch pad device separately from the display panel.

Accordingly, the first aspect of the present invention is a hand-held electronic device, which comprises:

a housing having a first section and a second section;

a display panel, disposed in the first section of the housing;

a flip, having an inner surface and an outer surface, movably connected to the second section of the housing via a hinge, wherein the flip is operable in a closed position or an open position;

a keypad having a plurality of keys disposed on the flip for inputting keypad functions; and

a touch pad device, disposed on the second section of the housing and facing the inner surface of the flip when the flip is in the closed position.

Preferably, the keypad is disposed on the outer surface of the flip.

Preferably, the keypad comprises a plurality of actuating members disposed on the inner surface of the flip associated with the keys on the keypads, wherein when the flip is in the closed position one or more actuating members can be caused to touch the touch pad device by pressing one or more keys, allowing the user to input keypad functions through the touch pad, and wherein when the flip is in the open position, the user can use the touch pad device for inputting information into the electronic device using an object to interact with the touch pad device.

The touch-pad device can be resistive-type, capacitive-type, inductive-type or surface wave type and the like.

However, it is preferred that the touch-pad device is an optical touch-pad device.

Preferably, the optical touch pad device comprises:

at least one group of optical sensor components including a first light emitter, a second light emitter and a light receiver disposed at different locations in or near a designated interactive area of the touch pad device such that the light receiver is capable of receiving a first amount of light emitted by the first light emitter and a second amount of light emitted by the second light emitter, wherein the first amount of light and the second amount of light are caused to change when the object is present at the designated interactive area;

a measurement module, operatively connected to the light receiver, for separately measuring the change in the first amount of light and the change in the second amount of light for providing a first signal and a second signal indicative of the respective changes; and

an electronic processor, responsive to the first signal and second signal, for determining the location of the object in the designated interactive area in relation to the first light emitter and the second light emitter based on the first and second signals, and interpreting the input information.

Preferably, the first and second light emitters are operated in a pulsed mode of a predetermined frequency so that the changes in the first amount of light and the second amount of light contain a frequency component of the predetermined frequency.

According to the present invention, the group of optical sensor components further includes a compensation emitter positioned adjacent to the light receiver to provide a compensation amount of light to the light receiver. It is preferred that the pulsed mode of the first and the second light emitters has a first phase, and the compensation light emitter is operated in a pulsed mode of the same frequency having a second phase complementary of the first phase. Furthermore, the compensation light emitter is controlled such that the compensation amount of light is substantially equal to a sum of the first amount and the second amount, when the object is not present at the designated interactive area.

According to the present invention, the optical components are operated in an infrared frequency range.

According to the present invention, the user is allowed to input information to the hand-held electronic device by moving the object to one or more locations at the designated interactive area, and the measurement module measures the changes in the first amount and the second amount of light as a function of time, and the electronic processor determines the location of the object in a repeated manner so as to track the movement of the object for interpreting the input function or the device function. The movement of the object is indicative of a symbol or a character of a written language, and the electronic processor interprets the symbol and character based on the tracked movement. Preferably, the display is used to display the symbol or character interpreted by the electronic processor.

It is possible that the keypad is disposed on the outer surface of the flip, wherein the keypad is electronically or optically linked to a signal processing module in the hand-held electronic device so as to allow the user to input keypad functions to the hand-held electronic device when the flip is in the closed position. Accordingly, it is possible that the keypad is disabled when the flip is in the open position and the touch pad device is disabled when the flip is in the closed position.

It is possible that the keypad is disposed on the inner surface of the flip, so as to allow the user to input keypad functions to the hand-held electronic device when the flip is in the open position.

According to the present invention, the hand-held electronic device further comprises a switching means operatively connecting the flip to the signal processor for indicating to the signal processor whether the flip is operated in the open position or the closed position.

The present invention will become apparent upon reading the description taken in conjunction with FIGS. 1a to 9.

### BRIEF DESCRIPTION OF THE DRAWINGS

FIG. 1a is a diagrammatic representation illustrating the front view of the mobile phone, according to preferred embodiment of the present invention, when the flip is in the open position.

FIG. 1b is a diagrammatic representation illustrating the front view of the mobile phone of FIG. 1a when the flip is in the closed position.

FIG. 1c is a diagrammatic representation illustrating the relationship between the actuating members associated with the keys on the keypad and the touch pad device in the mobile phone of FIG. 1a.

FIG. 1d is a diagrammatic representation illustrating a switching device operatively connected to a signal processing module for indicating to the signal processing module whether the flip is in the open position or in the closed position.

FIG. 2a is a diagrammatic representation illustrating another embodiment of the mobile phone, according to the present invention.

FIG. 2b is a diagrammatic representation illustrating means for conveying signals from the keypad to the signal processing module when the flip in the mobile phone of FIG. 2a is in the closed position.

FIG. 2c is a diagrammatic representation illustrating means for conveying signals from the touch pad device to the signal processing module when the flip is in the open position.

FIG. 2d is a diagrammatic representation illustrating optical means for conveying signals.

FIG. 3a is a diagrammatic representation illustrating yet another embodiment of the present invention, wherein the keypad is disposed on the inner surface of the flip.

FIG. 3b is a diagrammatic representation illustrating the mobile phone of FIG. 3a when the flip is in the closed position.

FIG. 4 is a diagrammatic representation illustrating a printed wire board or printed circuit board having a plurality of components disposed thereon.

FIG. 5 is a block diagram showing a plurality of components of the mobile phone, according to the present invention.

FIG. 6 is a block diagram showing a plurality of electronic components relating to the optical touch pad device.

FIG. 7a is a diagrammatic representation illustrating the upper left light emitter being used together with the upper light receiver to measure the location of a touching object.

FIG. 7b is a diagrammatic representation illustrating the upper right light emitter being used together with the upper light receiver to measure the location of a touching object.

FIG. 7c is a diagrammatic representation illustrating the lower left light emitter being used together with the lower light receiver to measure the location of a touching object.

FIG. 7d is a diagrammatic representation illustrating the lower right light emitter being used together with the lower light receiver to measure the location of a touching object.

FIG. 7e is a diagrammatic representation illustrating the upper left light emitter being used together with the lower light receiver to measure the location of a touching object.

FIG. 7f is a diagrammatic representation illustrating the upper right light emitter being used together with the lower light receiver to measure the location of a touching object.

FIG. 7g is a diagrammatic representation illustrating the lower left light emitter being used together with the upper light receiver to measure the location of a touching object.

FIG. 7h is a diagrammatic representation illustrating the lower right light emitter being used together with the upper light receiver to measure the location of a touching object.

FIG. 8 is a diagrammatic representation illustrating the use of a compensation emitter along with other optical sensor components in a touch pad device.

FIG. 9 is a diagrammatic representation showing a touch pad device having four groups of optical sensor components placed in the designated interactive area.

### BEST MODE FOR CARRYING OUT THE INVENTION

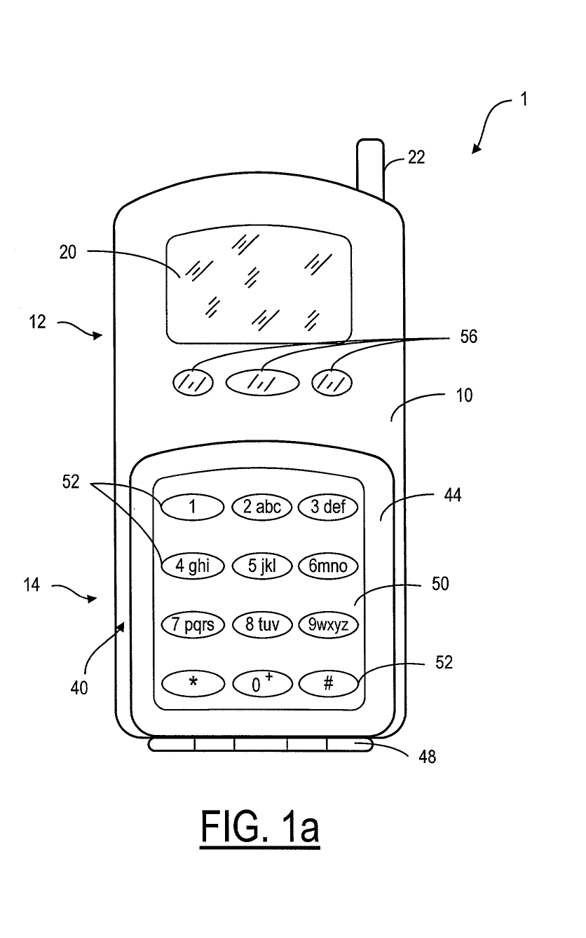

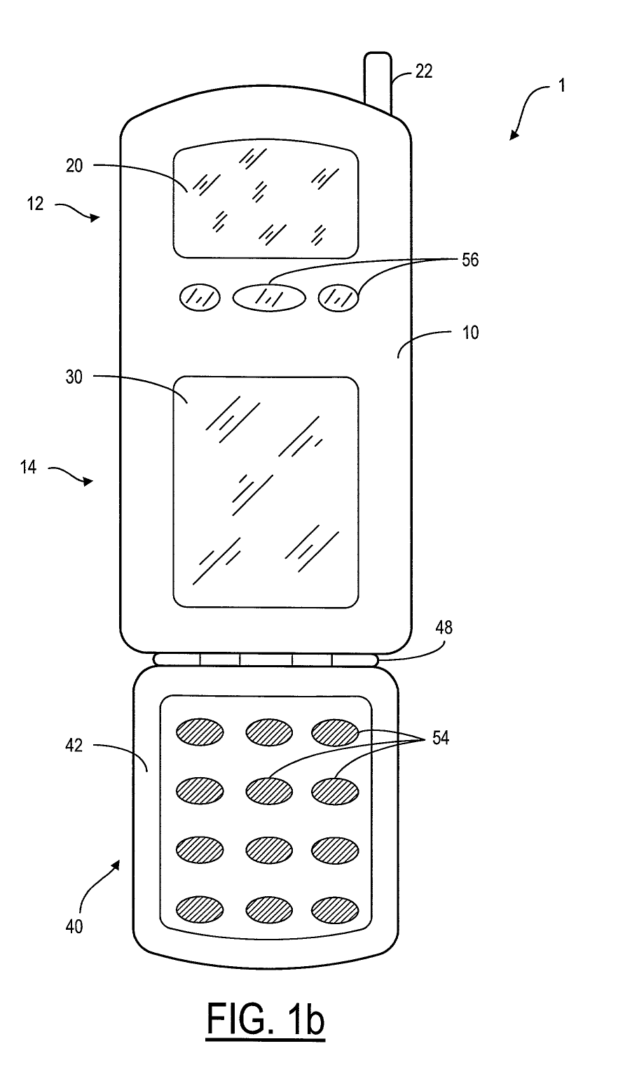

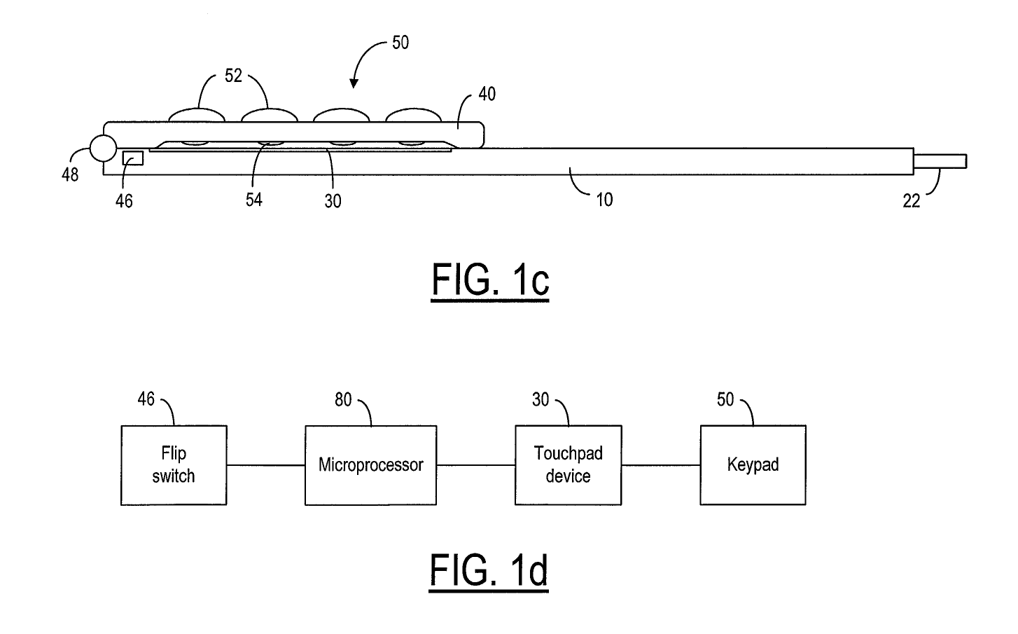

The hand-held electronic device, according to the present invention, can be a personal digital assistant (PDA), a communicator and the like. In particular, the hand-held electronic device is a mobile phone, as shown in FIGS. 1a and 1b. As shown in FIG. 1a, the mobile phone 1 has a housing 10 having an upper section 12 and a lower section 14. On the upper section 12, a display panel 20 is disposed for displaying information and an antenna 22 is disposed for transmitting and receiving signals in communication with other electronic devices. On the lower section 14, a touch pad device 30 (FIG. 1b) is disposed to allow a user to execute a device function or to input data/information into the mobile phone 1 by touching the touch pad device 30 with an object. The mobile phone 1 also has a keypad 50 with a plurality of keys 52 wherein the keypad 50 is disposed on the outer side 44 of a flip 40. Keys 52 may include alphanumeric keys for dialing, * and # keys, control keys, function keys and the like. The flip 40 is movably connected to the lower section 14 of the housing 10 via a hinge 48 so that the flip 40 can be operated in a closed position or in an open position. Preferably, the mobile phone 1 has a switching means 46 (FIG. 1c) to sense and indicate whether the flip 40 is in the open position or in the closed position. The flip is known in the art. As shown in FIG. 1a, the flip 40 is in the closed position, allowing the user to use the keypad 50 for inputting keypad functions. Preferably, a plurality of actuating members 54, associated with the keys 52 of the keypad 50, are disposed in the inner side 42 as shown in FIG. 1b. The actuating members 54 allow the user to input keypad functions through the touch pad when the flip 40 is in the closed position. As shown in FIG. 1c, the actuating members 54 are located in the proximity of the touch pad device 30 when the flip 40 is in the closed position. When the user presses one of the keys, for example, the actuating member 54 located directly below the key is caused to touch the touch pad device 30. The touch pad device 30 is designed such that, when the flip 40 is in the closed position, the touch pad device 30 is effectively a keypad, allowing the user to input keypad functions through the touch pad device 30 while using the keys 52 on the keypad 50. However, when the flip 40 is in the open position, the user must use an object to input information or device function through the touch pad device 30. Preferably, when the flip 40 is in the open position, the keypad 50 and the touch pad device 30 are effectively or functionally disconnected. As illustrated in FIG. 1d, the switching means 46 is operatively connected to a signal processor or microprocessor 80 to indicate to the microprocessor 80 whether the flip 40 is in the open position or in the closed position. Only when the flip 40 is in the closed position, is the keypad 50 effectively connected to the touch pad device 30, for inputting keypad functions through the touch pad device 30.

As shown in FIGS. 1a and 1b, the mobile phone 1 may have other keys 56, which are not located on the keypad 50. The keys 56 can be arrow keys or other control keys. However, keys 56 may also have keys that are on the keypad 50.

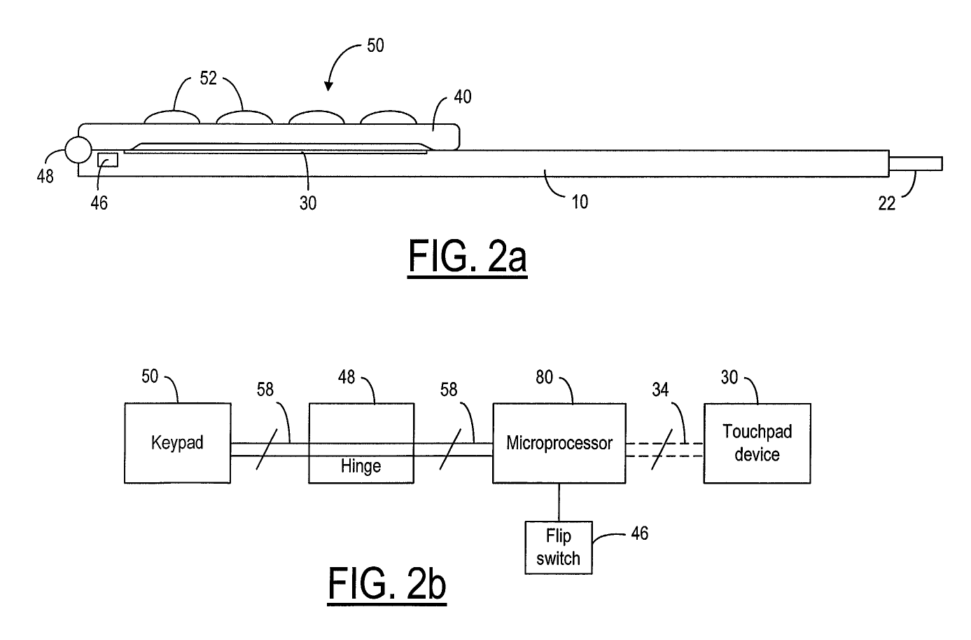

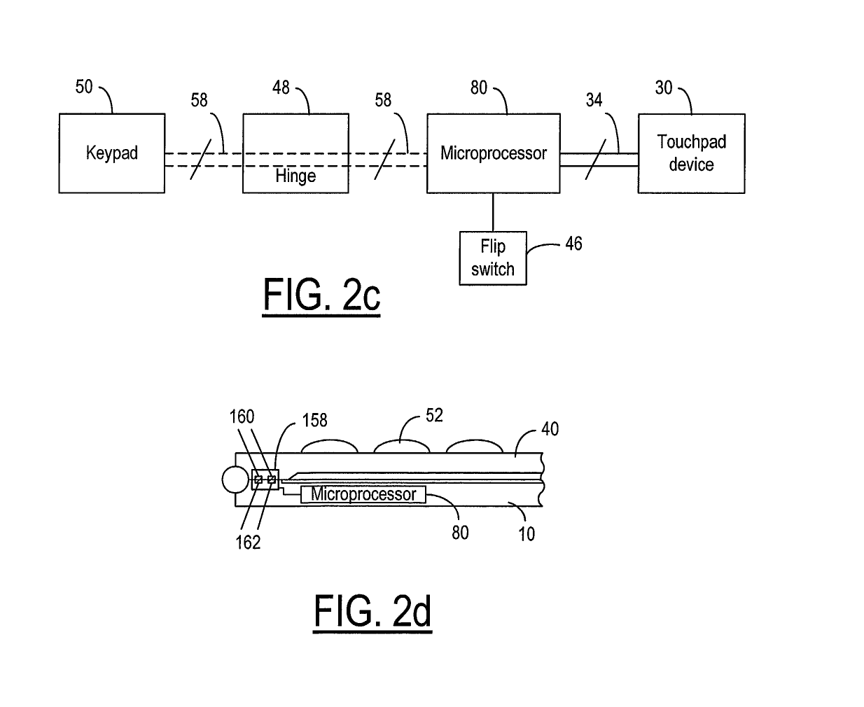

FIG. 2a illustrates another embodiment of the present invention. As shown in FIG. 2a, the keypad 50 and the touch pad device 30 are effectively two independent input devices. Accordingly, when the flip 40 is in the closed position, the user has no access to the touch pad device 30. As shown in 2b, the touch pad device 30 is effectively disconnected from the microprocessor 80, while the keypad 50 is connected to the microprocessor 80 via a signal conduit. The signal conduit can be electric wires 58 through the hinge 48. Alternatively, the signal conduit can be optical connectors 158, as shown in FIG. 2d. When the flip is in the open position, as indicated by the switching device 46, the keypad 50 is effectively disconnected from the microprocessor 80, as shown in FIG. 2c. As shown, the touch pad device 30 is operatively connected to the microprocessor 80 for allowing the user to input touch pad device functions to the microprocessor 80. The optical connector 158, as shown in FIG. 2d, comprising photo-receivers 162, which are capable of receiving light signals from photo-emitters 160 only when the flip 40 is in the closed position in order to input keypad functions to the microprocessor 80. The optical connector 158 can also be used as the switching device 46.

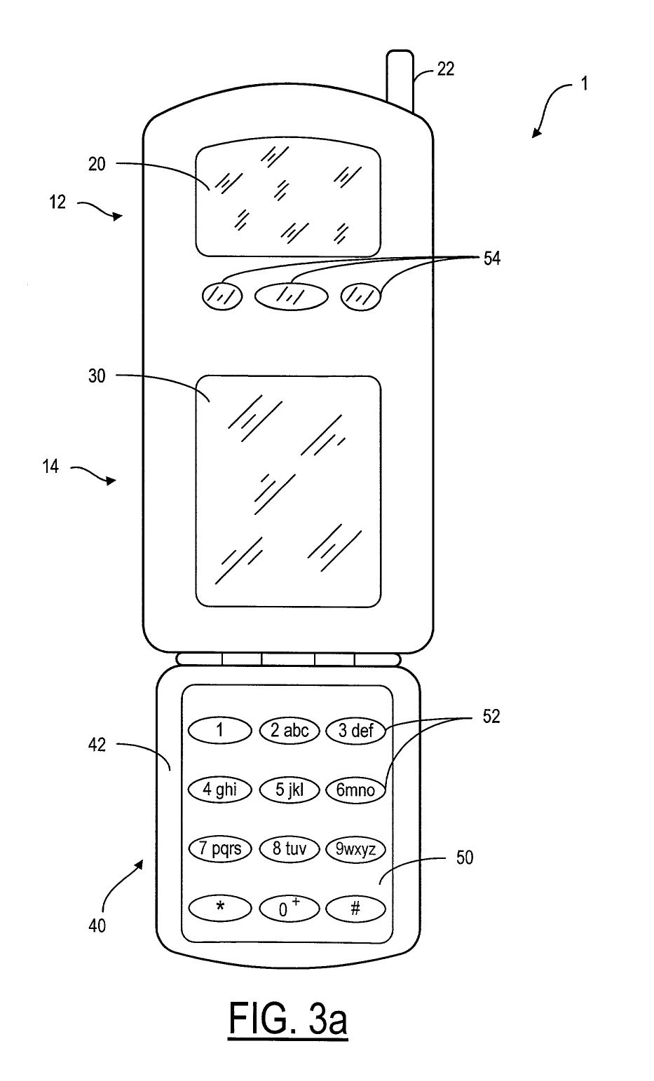

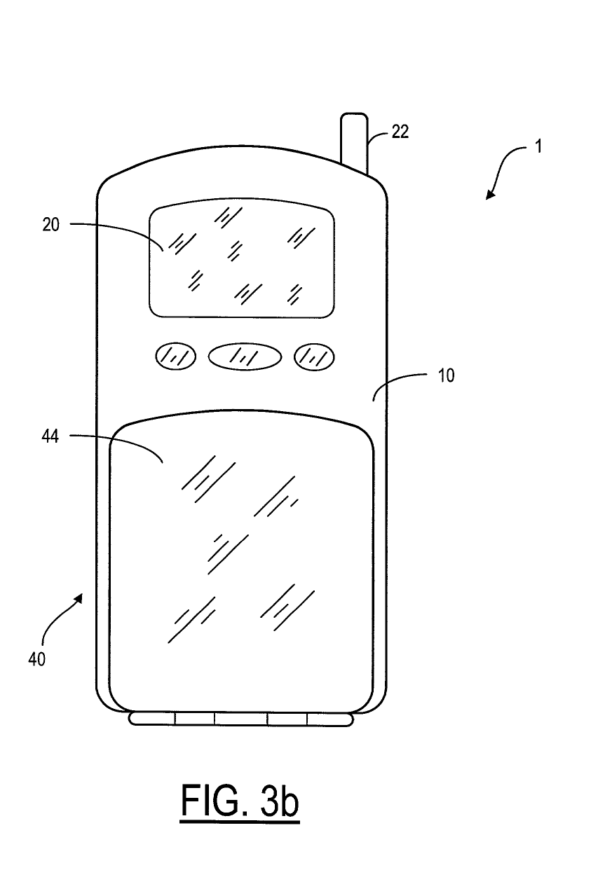

FIGS. 3a and 3b illustrate yet another embodiment of the present invention. As shown in FIG. 3a, the keypad 50 is disposed on the inner side 42 of the flip 40. When the flip 40 is in the open position, the user can either use the keypad 50 or the touch pad 30 to input information to the mobile phone 1. When the flip 40 is in the closed position, as shown in FIG. 3b, the outer side 44 of the flip 40 is used as a protective cover for the touch pad device 30 and the keypad 50.

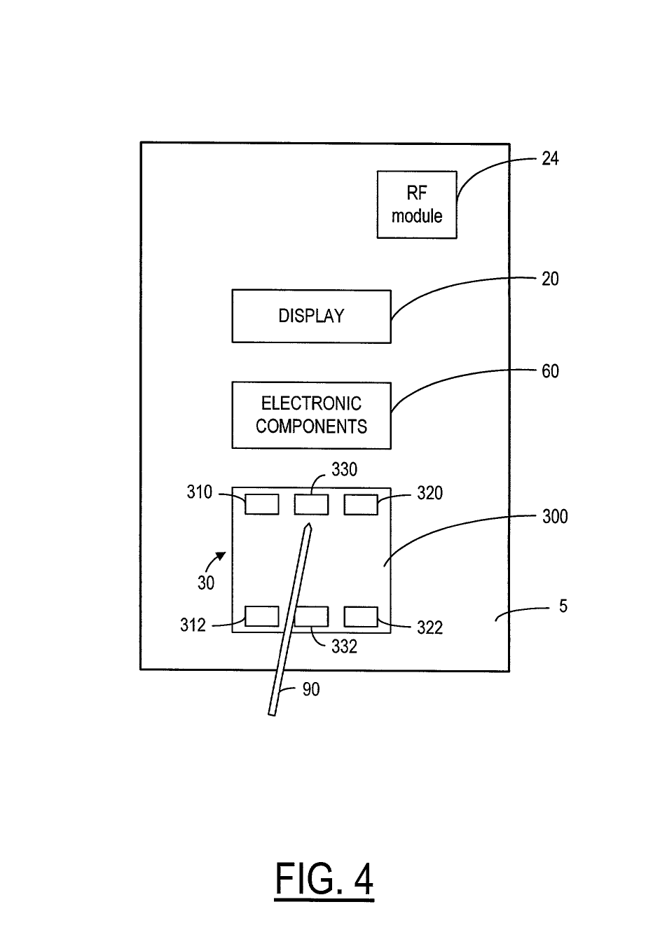

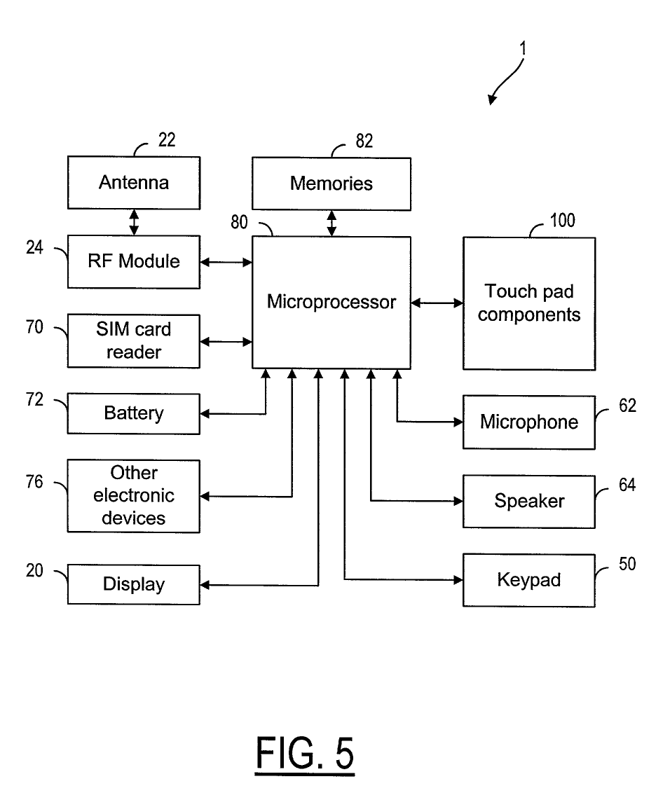

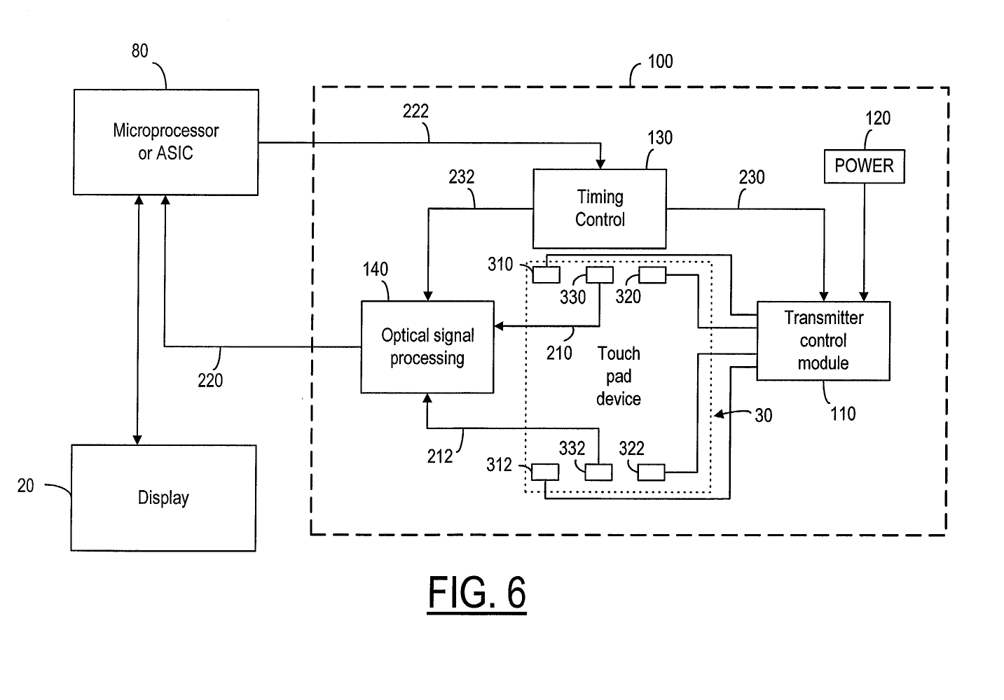

On the mobile phone 1 of the present invention, the touch pad device 30 and the display panel 20 are physically separated from each other. The arrangement is advantageous over prior art mobile phones in that the display panel 20 and the touch pad device 30, along with other electronic components 60 can all be disposed on a printed wire board (PWB) or printed circuit board (PCB) 5. The other electronic components 60 include a microprocessor 80, memories 82 (FIG. 5), a timing control module 130 and other electronic modules as shown in FIG. 6. As shown in FIG. 4, an RF module 24, which is operatively connected to the antenna 22 (FIGS. 1a and 1b), is also disposed on the PWB 5. Furthermore, because the touch pad device 30 is separated from the display panel 20, the touch pad device 30 does not have to be entirely transparent. With the touch pad device 30 being separated from the display panel 20, the touch pad device 30 can be a capacitive-type, resistive-type, inductive-type or a surface-wave type. Preferably, the touch pad device 30 is an optical type, which has a plurality of optical sensor components 310, 312, 320, 322, 330 and 332 disposed near the edges of a designated interactive area 300, as shown in FIG. 4. These optical sensor components are used to detect the presence of an object 90 that the user uses to interact with the touch pad device 30 at the designated interactive area 300. The object 90 can be a finger, or a stylus, as shown in FIG. 4.

FIG. 5 is a block diagram showing the basic components of the mobile phone 1. As shown, the mobile phone 1 includes the microprocessor 80, which is operatively connected to touch pad components 100 of the optical touch pad device 30, a microphone 62, a speaker 64, the keypad 50, the display panel 20, a battery pack 72, and the RF module 24 electronically connected to the antenna 22. In addition, the mobile phone 1 may comprise a SIM card reader 70 and other electronic devices 76. The other electronic devices 76 may include an optical scanner, an IR transmitter/receiver, and so forth. The touch pad components 100 are shown in FIG. 6.

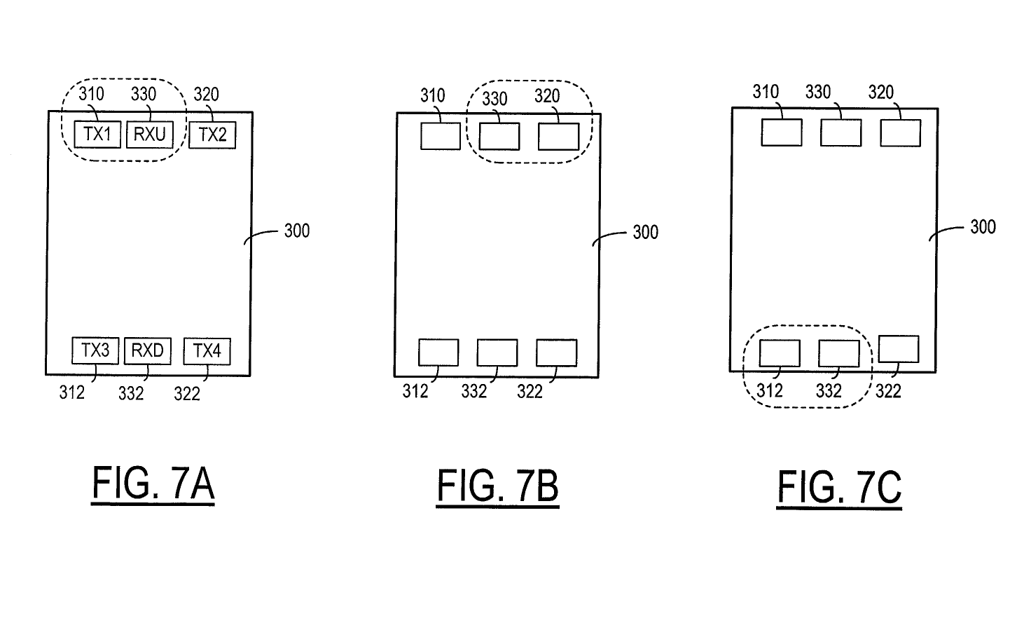

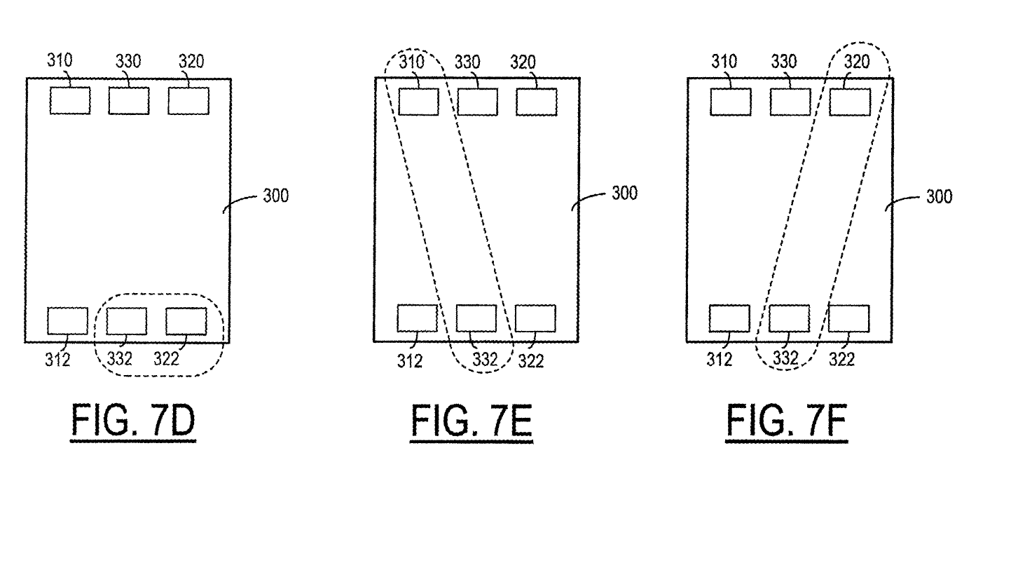

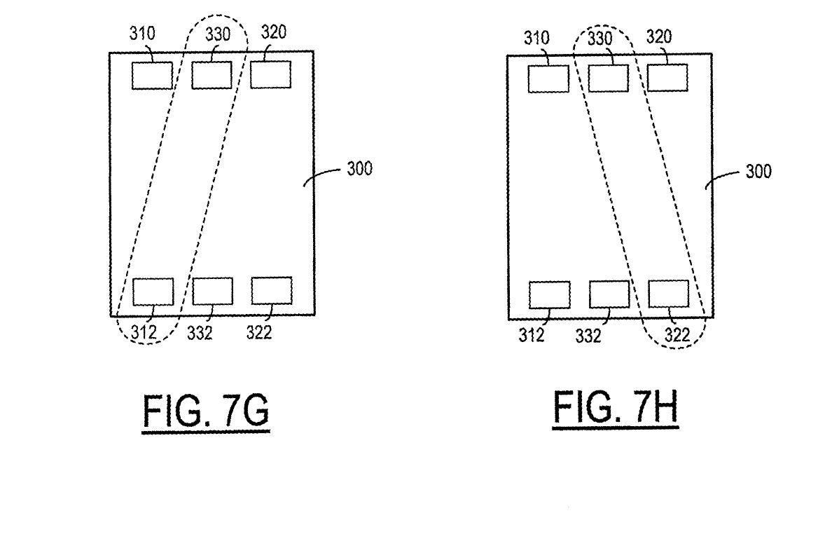

The touch pad components 100 shown in FIG. 6 include a transmitter control module 110, a timing control module 130 and an optical signal processing module 140, separately connected to two groups of optical sensor components. The transmitter control module 110 is also connected to a power source 120, which supplies power to the optical sensor components. One group of optical sensor components includes two light transmitters or emitters 310, 320 and one light receiver 330. The other group of optical sensor components includes two light emitters 312, 322 and one light receiver 332. The principle of the optical-type touch pad device 30 is described in detail in pending patent application Ser. No. 09/928,967, entitled “Method and Device for Detecting Touch Pad Input”, filed Aug. 13, 2001, and pending patent application Ser. No. 09/928,929, entitled “Method for Preventing Unintended Touch Pad Input Due to Accidental Touching”, filed Aug. 13, 2001. These patent applications are hereby incorporated herein by reference. The touch pad 30 will also be described below in conjunction with FIGS. 7a-7h. As shown in FIG. 6, the emitters 310, 312, 320, 322 are connected to the transmitter control module 110, which selectively enables or disables the emitters for measurements. The output signal 210 from the receiver 330 and the output signal 212 from the receiver 332 are conveyed to the optical signal-processing module 140. The transmitter control module 110 and the optical signal-processing module 140 are under the control of a timing control module 130. For example, in order to use the emitter 310 and the receiver 330 for measurement, the timing control module 130 sends out a control signal 230 to the transmitter control module 110 for turning off or disabling the emitters 312, 320, 322 and enabling the emitter 310. At the same time, the timing control module 130 sends out a control signal 232 to the optical signal processing module 140 such that only the output signal 210 from the receiver 330 is used for measurement. Based on the output signal 210, the optical signal processing module 140 sends measurement information 220 to the microprocessor 80. After receiving the measurement information 220, the microprocessor 80 sends out a command signal 222 to the timing control module 130 for starting the measurement using other combinations of emitters and receivers.

As shown in FIGS. 4 and 6, the optical sensor components include light emitters 310, 312, 330 and 332, and light receivers 330 and 332. The receiver 330 is capable of receiving light emitted by the emitters 310 and 320, and the receiver 332 is capable of receiving light emitted by the emitters 312 and 322. When a user uses an object, such as the user's finger or the stylus 90, to “touch” the designated interactive area 300 or the touch pad device 30, light emitted by the emitters 310 and 320 encounters the stylus 90 and reflects off the stylus 90 to the receiver 330, thereby causing a change in the output 210 (FIG. 6) of the receiver 330. Likewise, light emitted by the emitters 312 and 322 encounters the stylus 90 and reflects off the touching object to the receiver 332, causing a change in the output 212 (FIG. 6) of the receiver 332. The changes in the receiver output can be used to detect the presence of the stylus 90, as well as the location of the “touch” point within the designated interactive area 300 (FIG. 4). It should be noted that the touch pad device 30 can be used for executing a single touch pad function, or it can be used for executing a plurality of touch pad functions based on the location of the touch point. In order to determine the location of the touching point, it is preferable to carry out a series of eight measurement cycles, as shown in FIGS. 7a-7h and TABLE I. In each measurement cycle, only one emitter and one receiver are used for measurement—the used emitter and receiver in the measurement are in a dashed loop. For example, in the first measurement cycle, the emitter 310 and the receiver 330, as shown in FIG. 7a, are used to measure the change in the output 210 attributable to the emitter 310. The emitters 312, 320, 322 and the receiver 332 are turned off or disabled. As shown in FIG. 7b, the emitter 320 and the receiver 330 are used for the second measurement cycle. The measurement results from the first measurement cycle and the second measurement cycle are compared in order to determine the horizontal location of the touch point. Additionally, the measurement result from the emitter 312/receiver 332 pair (FIG. 7c) is compared to the measurement result from the emitter 322/receiver 332 pair (FIG. 7d) to further determine the horizontal location of the touch point. From these four measurements (FIGS. 7a-7d), it is possible to calculate the two-dimensional coordinates of the touch point. However, in order to improve the accuracy in location determination, it is preferable to also carry out the following measurements: the emitter 310/receiver 332 pair (FIG. 7e); the emitter 320/receiver 332 pair (FIG. 7f); the emitter 312/receiver 330 pair (FIG. 7g) and the emitter 322/receiver 330 pair (FIG. 7h). The series of eight measurements are summarized in TABLE I, where TX1=emitter 310, TX2=emitter 320, TX3=emitter 312, TX4=emitter 322, RXU=receiver 330 and RXD=receiver 332.

TABLE I

| | TX1 | RXU | TX2 | TX3 | RXD | TX4 | measured direction |
|---|---|---|---|---|---|---|---|
| 1 | on | on | off | off | off | off | horizontal, upper |
| 2 | off | on | on | off | off | off | horizontal, upper |
| 3 | off | off | off | on | on | off | horizontal, lower |
| 4 | off | off | off | off | on | on | horizontal, lower |
| 5 | off | on | off | on | off | off | diagonal/ |
| 6 | off | off | on | off | on | off | diagonal/ |
| 7 | on | off | off | off | on | off | diagonal\ |
| 8 | off | on | off | off | off | on | diagonal\ |

It should be noted that when the touch pad device 30 is used by the user to draw a symbol or to write a character of a written language, it is necessary to repeat the measurement cycles so that the location of the touch point as a function of time can be traced by the microprocessor 80. Based on a number of touch points, the microprocessor 80 recognizes the symbol or the character based on a look-up table or a character recognition software. While the user moves the stylus 90 in the designated interactive area 300, it is possible to display a trace representing the user's movement on the display panel 20.

The emitters 310, 312, 320 and 322 can be operated in a continuous mode in that the output of the emitters does not contain a high frequency component, similar to the output of an incandescent lamp. Accordingly, the output signal 210 (FIG. 6) of the receiver 330 is also constant or slowly varying. When the emitters are operated in a continuous mode, the output signal of the receiver can be significantly affected by ambient light. This means that the output signal of the receiver may vary from one location to another, regardless of whether the touching object is present at the touch pad device. When the output variation due to ambient light is significant, the detection and sensing of the presence of the touching object becomes difficult, if not impossible. Thus, it is preferable that these emitters be operated in a pulsed mode such that the emitters are turned on and off at regular intervals at a selected frequency. When the receiver receives light from the pulsed emitter, regardless of whether the touching object is present at the touching pad device, the output of the receiver contains a frequency component, with the output of the receiver and the light emitted from the emitters being in-phase with each other. Usually, as ambient light varies much slower than the frequency of the pulsed frequency, the variation in the output signal of the receiver due to the variation in ambient light is most likely a shift in the base line of the output signal. The output variation due to ambient light can be easily removed using a high-pass filter, for example. Therefore, the variation in the pulsed output signal of the receiver is mainly the result of the reflection or absorption of the approaching object over the touch pad device.

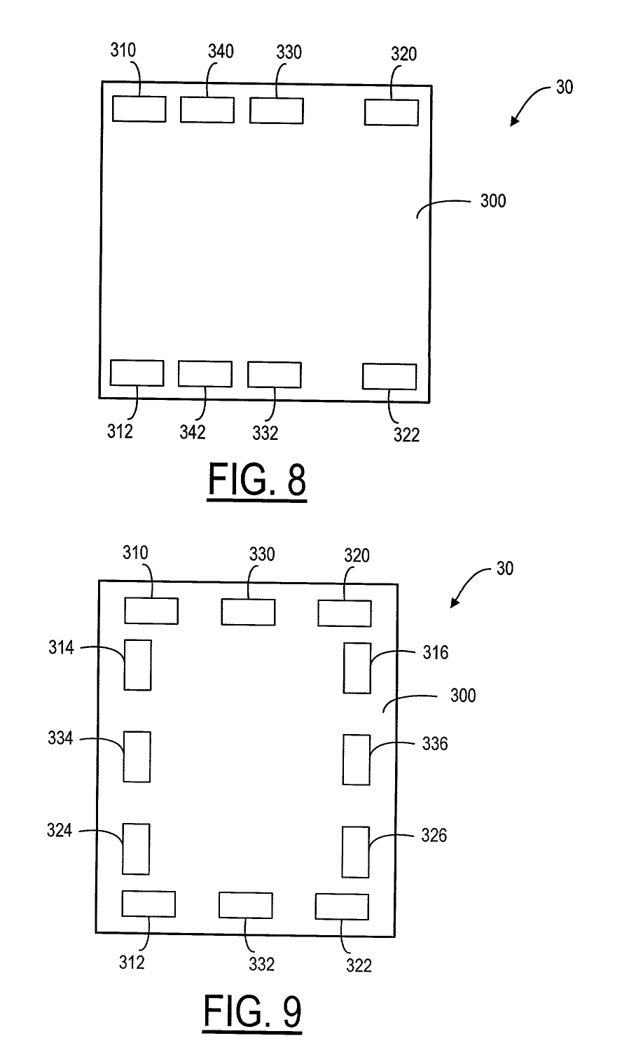

It should be noted that the output signal of the receiver 330 attributable to a pulsed emitters 310 and 312, as shown in FIGS. 4 and 6, can change if the surface of the touch pad device 30 is wet or dirty. Such a change could complicate the detection and sensing of the touching object. Thus, it is also preferable to place a compensation emitter 340 adjacent to the receiver 330, as shown in FIG. 8. The compensation emitter 340 is also operated in a pulsed mode such that the phase of the compensation emitter 340 is complementary to the phase of the emitters 310, 320. The compensation emitter 340 is controlled such that when the touching object is not present, the output signal 210 of the receiver 330 attributable to the emitters 310, 320 is substantially equal to that attributable to the compensation emitter 340. With such a compensation emitter, the output signal of the receiver 330 does not contain a high frequency component, when the touching object is not present. Thus, after being filtered by a high-pass filter, the output signal of the receiver 330 is substantially zero. With such a compensation emitter, the output signal of the receiver 330 is substantially unaffected by the surface condition of the touch pad device 30. Likewise, another compensation emitter 342 is placed adjacent to the receiver 332 to cancel out the high frequency component in the output 212 (FIG. 6) from the receiver 332 when the touching object is not present at the touch pad device 30. The use of a compensation emitter has been disclosed in U.S. Pat. No. 5,666,037 entitled “Arrangement for measuring or detecting a change in a retro-reflective element” to Gerd Reime, and in EP 0 706 648 B1 of the same title to the same inventor.

Four groups of sensor components can be placed on four sides of the designated interactive area 300, as shown in FIG. 9. Similar to the measurements using the emitters 310, 312, 320, 322 and receivers 330, 332, as shown in FIGS. 7a-7h and summarized in TABLE I, another series of eight measurements can be carried out with emitters 314, 316, 324, 326 and receivers 334, 336. At any one time, only one emitter and one receiver are turned on for measurement.

The present invention has been described mainly in conjunction with an optical touch pad device. It should be noted, however, a touch pad device of a different type can also be used on the mobile phone 1 of the present invention. Thus, the touch pad device can be resistive-type, capacitive-type, inductive-type, surface-wave type and the like. Furthermore, the mobile phone 1 can have more or less electronic components than those illustrated in FIG. 5.

Thus, although the invention has been described with respect to a preferred embodiment thereof, it will be understood by those skilled in the art that the foregoing and various other changes, omissions and deviations in the form and detail thereof may be made without departing from the spirit and scope of this invention.

What is claimed is:

1. A hand-held electronic device comprising:
a housing having a first section and a second section;
a display panel disposed in the first section of the housing;
a flip movably connected to the second section of the housing between an open position and a closed position, wherein the flip has an inner surface and an outer surface;
a keypad, disposed on the flip, having a plurality of keys for allowing a user to press one or more keys to input keypad functions; and
a touch pad device, disposed on the second section of the housing and facing the inner surface of the flip when the flip is in the closed position, wherein when the flip is in the open position, the user can use the touch pad device for inputting information into the electronic device using an object to interact with the touch pad device.

2. The hand-held electronic device of claim 1, wherein the touch pad device is a resistive-type device.

3. The hand-held electronic device of claim 1, wherein the touch pad device is a capacitive-type device.

4. The hand-held electronic device of claim 1, wherein the touch pad device is an inductive-type device.

5. The hand-held electronic device of claim 1, wherein in the touch pad device is a surface wave-type device.

6. The hand-held electronic device of claim 1, wherein the touch pad device is an optical-type device.

7. The hand-held electronic device of claim 6, wherein the touch pad device comprises:
at least one group of optical sensor components including a first light emitter, a second light emitter and a light receiver disposed at different locations in or near a designated interaction area of the touch pad device such that the light receiver is capable of receiving a first amount of light emitted by the first light emitter and a second amount of light emitted by the second light emitter, wherein the first amount of light and the second amount of light are caused to change when the object is present at the designated interaction area;
a measurement module, operatively connected to the light receiver, for separately measuring the change in the first amount of light and the change in the second amount of light for providing a first signal and a second signal indicative of the respective changes; and
an electronic processor, responsive to the first signal and second signal, for determining the location of the object in the designated interaction area in relation to the first light emitter and the second light emitter based on the first and second signals, and interpreting the input information.

8. The hand-held electronic device of claim 7, wherein the first and second light emitters are operated in a pulsed mode of a predetermined frequency so that the changes in the first amount of light and the second amount of light contain a frequency component of the predetermined frequency.

9. The hand-held electronic device of claim 8, wherein the pulsed mode of the first and the second light emitters has a first phase, and wherein said group of optical sensor components further includes a compensation light emitter positioned adjacent to the light receiver to provide a compensation amount of light to the light receiver, and the compensation light emitter is operated in a further pulsed mode of the predetermined frequency having a second phase complementary of the first phase and the compensation light emitter is controlled such that the compensation amount of light is substantially equal to a sum of the first amount and the second amount, when the object is not present at the designated interactive area.

10. The hand-held electronic device of claim 6, wherein the first and second light emitters are light-emitting diodes.

11. The hand-held electronic device of claim 6, wherein the first and second light emitters are operated in an infrared frequency range.

12. The hand-held electronic device of claim 1, further comprising means for receiving and transmitting signals for facilitating telecommunication with other electronic devices.

13. The hand-held electronic device of claim 1, wherein the user inputs information to the hand-held electronic device by moving the object to one or more locations at the designated interaction area, and the measurement module measures the changes in the first amount and the second amount of light as a function of time, and the electronic processor determines the location of the object in a repeated manner so as to track the movement of the object for interpreting the input function or the device function.

14. The hand-held electronic device of claim 13, wherein the movement of the object is indicative of a symbol, and the electronic processor interprets the symbol based on the tracked movement.

15. The hand-held electronic device of claim 13, wherein the movement of the object is indicative of a character of a written language and the electronic processor interprets the character based on the tracked movement.

16. The hand-held electronic device of claim 15, wherein the display can be used to display the character interpreted by the electronic processor.

17. The hand-held electronic device of claim 1, wherein the keypad is disposed on the outer surface of the flip.

18. The hand-held electronic device of claim 17, wherein the keypad further comprises a plurality of actuating members associated with the keys and disposed on the inner surface of the flip, such that when the flip is in the closed position, the actuating members are located in the proximity of the touch pad device and the actuating members can be caused to touch the touch pad device when the user presses at least one of the keys to input the keypad functions through the touch pad device.

19. The hand-held electronic device of claim 18, wherein the keypad is disabled when the flip is in the open position.

20. The hand-held electronic device of claim 17, wherein the touch pad device is disabled when the flip is in the closed position.

21. The hand-held electronic device of claim 1, wherein the keypad is disposed on the inner surface of the flip and wherein the user can input keypad functions using the keypad when the flip is in the open position.
